(19) United States
(12) Patent Application Publication
(10) Pub. No.: US 2003/0086579 A1
(43) Pub. Date: May 8, 2003

(54) Apparatus and method of controlling signal levels

(76) Inventors: Tatiana A. Lashina, Eindhoven (NL); Paul Philip Thursfield, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/278,283

(22) Filed: Oct. 23, 2002

(30) Foreign Application Priority Data
Oct. 26, 2001 (EP) 01204068.9

(51) Int. Cl. H04B 1/00

(52) U.S. Cl. 381/119; 369/4

(57) ABSTRACT

The invention relates to an apparatus (200) for controlling and mixing signals, each having their individual control member (212, 213, 214, 215). In known mixer apparatuses (100), the direct transfer of the level of the input signal to the output signal cannot be seen directly. Therefore, it is proposed that the control members (212, 213, 214, 215) corresponding to the respective input signals show the direct transfer of the input signal to the output signal. It is proposed to control the level of the output signal as a whole by means of one main control member (211). When the main control member (211) is moved and controls the level of the output signal, the control members (212, 213, 214, 215) corresponding to the respective input signal move along with it and preserve the relationship between the control levels of the individual input signals in the output signal. The invention also relates to a method and a record carrier (510).

The invention relates to an apparatus as defined in the precharacterizing part of claim 1.

The invention relates to a method as defined in the precharacterizing part of claim 3.

The invention further relates to a record carrier as defined in the precharacterizing part of claim 5.

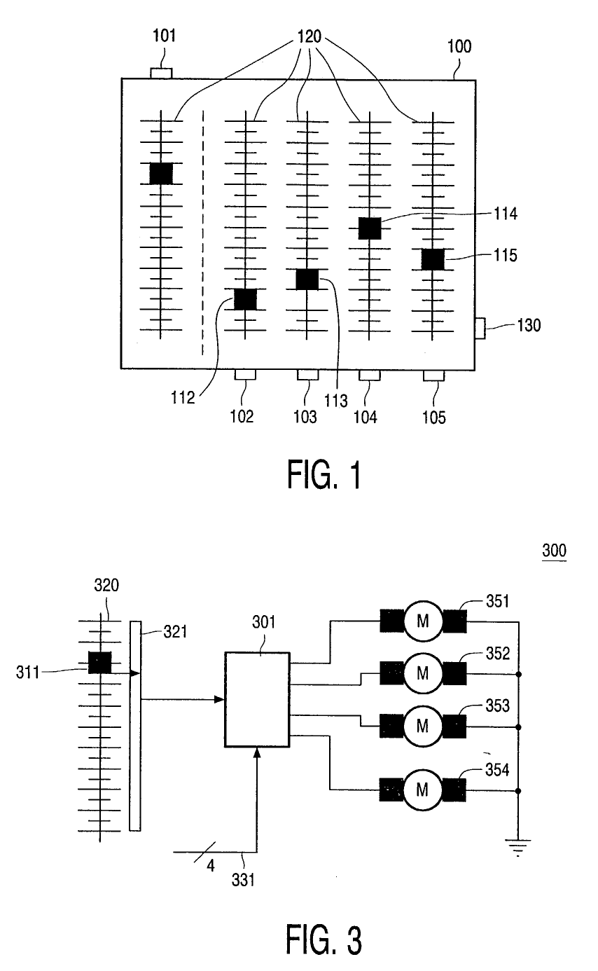

An embodiment of such an apparatus is shown in FIG. 1 and known to those skilled in the art, for example, as a mixer of sound signals.

A drawback of such an apparatus is that there is no direct relationship between the control value of an input signal and the output signal. To retrieve this relationship, the control values of the input signal and the output signal should be multiplied by each other.

It is an object of the invention to provide an apparatus which is more user-friendly.

According to the invention, this object is achieved with an apparatus which is characterized in that the apparatus is further adapted that its individual control members are coupled to the main control member, such that, when determining the level of the output signal by moving the movable main control member, the individual movable control members move along with the main control member in order that the ratios between the mutual levels of the controllable signals remain equal, and that the transfer of the levels of the controllable signals in the output signal is directly readable from the position of the individual control members.

An advantage of such an apparatus is that a user can directly read the transfer of an input signal to the output signal on the apparatus. Moreover, the level of the output signal can also be controlled, while the ratios between the levels of presence of the input signals are preserved in the main signal.

The method according to the invention is characterized in that the individual control members are coupled to the main control member, such that, when controlling the level of the output signal by moving the movable main control member, the individual control members move along with the movable main control member, and that the transfer of the levels of the controllable signals is directly shown by the position of the individual control members.

The record carrier according to the invention is characterized in that the instructions enable the processor to perform the method as defined in claim 3.

These and other aspects of the invention are apparent from and will be elucidated with reference to the embodiments described hereinafter.

In the drawings:

FIG. 1 shows an apparatus in accordance with the prior art;

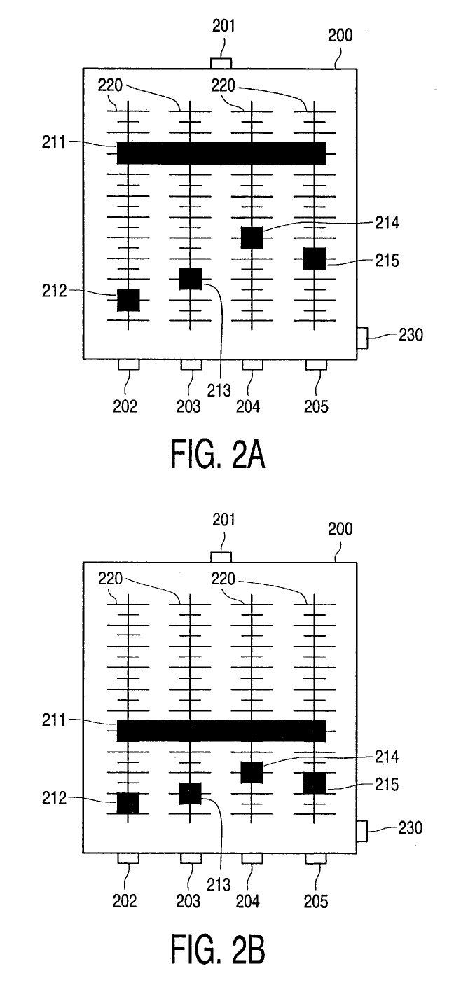

FIGS. 2A and 2B show an embodiment of an apparatus according to the invention;

FIG. 3 shows a system for use in an embodiment of an apparatus according to the invention;

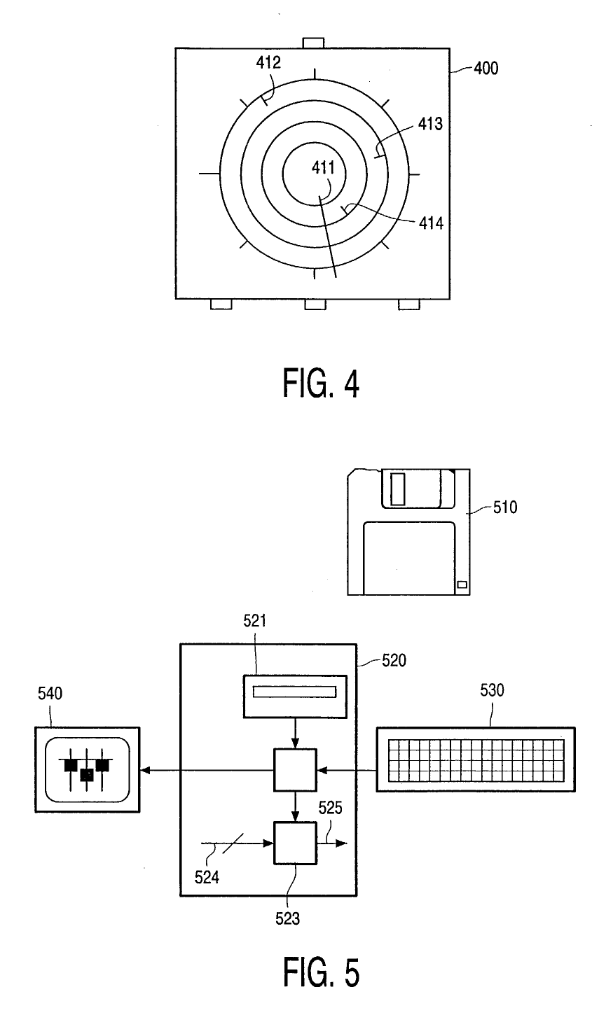

FIG. 4 shows a further embodiment of an apparatus according to the invention; and

FIG. 5 shows an embodiment of a record carrier according to the invention, and a computer.

FIG. 1 shows an apparatus 100 as an embodiment known from the prior art. The apparatus 100 is known as a mixer to those skilled in the art. Such a mixture is used for mixing a plurality of input signals into one or more output signals. The signals may comprise sound but also, for example, control signals for a system. The apparatus 100 has a first input 102 for a first input signal, a second input 103 for a second input signal, a third input 104 for a third input signal and a fourth input 105 for a fourth input signal. The apparatus 100 also has an output 101 for supplying an output signal. These outputs may be, for example, plugs, but it is known to those skilled in the art that these outputs may be formed by any other known connection. By means of a first control member 112, a second control member 113, a third control member 114 and a fourth control member 115, the ratios of the presence of the first input signal, the second input signal, the third input signal and the fourth input signal, respectively, in the output signal are controlled. Moreover, a main control member 111 controls the level of the output signal. The signals may be controlled by a user but also by a further apparatus, a further input 130 of which is connected to the apparatus 100.

To determine the ultimate transfer with which one of the four input signals is passed on by the apparatus 100 to the output signal, both the position of the main control member 111 and the position of the control members 112 to 115 of the input signal should be read and subsequently the total transfer should be computed. For the sake of convenience, a scale 120 is shown with each control member on the apparatus 100. The scale 120 comprises ten units which are each subdivided into two sub-units. In this way, the transfer of, for example, the third input signal can be computed. The third control member is at 40% and the main control member is at 80%. The transfer of the third input signal is thus 40% multiplied by 80% and is therefore 32%. Consequently, the direct transfer from an input signal to the output signal cannot be directly read from the apparatus 100.

FIG. 2A shows an apparatus 200 as an embodiment of the invention. The apparatus 200 has a first input 202 for a first input signal, a second input 203 for a second input signal, a third input 204 for a third input signal and a fourth input 205 for a fourth input signal. Moreover, the apparatus 200 has an output 201 for supplying an output signal. These outputs may be, for example, plugs but it is known to those skilled in the art that these outputs may be in the form of any other connection. By means of a first control member 212, a second control member 213, a third control member 214 and a fourth control member 215, the ratios of the presence of the first input signal, the second input signal, the third input signal and the fourth input signal, respectively, in the output signal are controlled. The output signal is thus a weighted sum of the input signals in which the weights of the input signals in the output signal are determined by the first control member 212, the second control member 213, the third control member 214 and the fourth control member 215. The apparatus 200 also has a main control member 211.

The apparatus 200 is adapted to be such that transfer of the input signals to the output signal is directly controlled by the control members 212 to 215. The transfer of input signals to the output signal can thus be directly read on a scale 220 at the position where the control member is situated.

To control the level of the output signal without disturbing the ratios between the levels of the input signals in the output signal, the main control member 201 can be moved. According to the invention, the individual control members 212 to 215 move along with the main control member, while the ratios between control values indicated by the individual control members 212 to 215 on the scale 220 remain equal. This is illustrated in FIG. 2B. FIG. 2B shows the same apparatus 200 as FIG. 2A, with the difference that the level of the control members 211 to 212 is half the level of the control members shown in FIG. 2A. By halving the level of the main control member 211, the levels of the control members 212 to 215 of the input signals are also halved according to the invention. The control members 212 to 215 of the input signals thus move along with the main control member 211, in both directions. An exception occurs when a control member is already at level 0, i.e. at the bottom of the scale 220 in the apparatus 200. In this case, the control member will not move along with the main control member.

The coupling between the main control member 211 and the control members 212 to 215 of the input signals may be mechanical. In a preferred embodiment of the invention, the control members 212 to 215 of the input signals are electromechanicallly coupled to one another. This means that the control members 212 to 215 of the input signals move along with the main control member 211 when this main control member is moved.

If one of the further control members 212 to 215 is moved, the other ones of the further control members 212 to 215 do not move along with this control member.

FIG. 3 shows a system 300 for realizing this. The system 300 comprises a main control member 311, a scale 320, a position sensor 321 (which may be, for example, a sliding potentiometer), a processing unit 301 and motors 351 to 354. Moreover, the system comprises further control members for controlling the ratios between the input signals in the output signal, each control member also being provided with a position sensor. These position sensors are equal to the position sensor 321 and are not shown in the Figure for the sake of simplicity. In the shown embodiment of the invention, the system 300 comprises four further control members with four further position sensors. The outputs of these position sensors are indicated as signal 331 which is coupled to the processing unit 301. Moreover, the output of the position sensor 321 is coupled to the processing unit. If the main control member 311 is moved, the output signal of the position sensor 321 changes. Based on the change of the output signal of the position sensor 321, the processing unit 301 computes the new position of the further control members. The computation also takes the position of the further control members into account, which position is passed on via the signal 331. The output of the processing unit 301 is coupled to the motors 351 to 354 which are coupled to the further control members. After movement of the main control member 311, the processing unit 301 supplies such a signal to each of the four motors 351 to 354 that the further control members are positioned at the correct location. The transmission of the motors to the further control member is effected in a manner known to those skilled in the art, for example, by means of gear wheels or belts.

In a further embodiment, the apparatus 200 of FIG. 2 has a control input 230. In a preferred embodiment, the control members of the apparatus 200 are operated by a user. However, it is alternatively possible to drive the apparatus 200 by means of a further apparatus. The movement of the control members is then controlled by the motors 351 to 354 (FIG. 3) and the main control member 311 (FIG. 3) which, in such an embodiment, is also provided with a motor (not shown).

In a preferred embodiment, further control members 212 to 215 (FIG. 2) then move along with the main control member 211 (FIG. 2) when this member is moved both upwards and downwards so as to control the level of the output signal to a high or a low value, respectively. In a further embodiment, the further control members 212 to 215 (FIG. 2) move along with the main control member 211 (FIG. 2) only when the main control member 211 (FIG. 2) is moved downwards. If the main control member 211 (FIG. 2) is moved in the other direction, the further control members 212 to 215 (FIG. 2) do not move along with it.

In yet another embodiment, the further control members 212 to 215 (FIG. 2) move along with the main control member 211 (FIG. 2) only when the main control member 211 (FIG. 2) is moved upwards. If the main control member 211 (FIG. 2) is moved into the other direction, the further control members 212 to 215 (FIG. 2) do not move along with it.

In a further embodiment of the invention, the main control member 211 (FIG. 2) limits the position of the further control members 212 to 215 (FIG. 2). This means that the further control members 212 to 215 (FIG. 2) cannot be moved further or higher than the position of the main control member 211 (FIG. 2).

FIG. 4 shows a further embodiment of the invention. FIG. 2 shows an apparatus 200 as an embodiment with sliders and FIG. 4 shows an apparatus 400 as an embodiment with knobs. The level of the output signal is controlled on the apparatus 400 by means of a main control knob 411. The ratios between the levels of the input signals is controlled by means of the further control knobs 412, 413 and 414.

FIG. 5 shows a diskette 510 as an embodiment of a record carrier according to the invention, comprising instructions enabling a processor to perform the method according to the invention. The record carrier 510 may be used in a computer 520. This may be a personal computer but also, for example, a personal digital assistant, a digital television or a UNIX workstation. The computer 520 comprises a diskette station 521 which is connected to a processor 522. The processor 522 is further connected to a signal-processing circuit 523 having a plurality of inputs 524 and an output 525. The diskette station 521 is adapted to read information from the diskette 510 and to pass on this information to the processor 522. The information comprises instructions which can be performed by the processor 522 and enable the processor 522 to control input signals at the plurality of inputs 524 of the signal-processing circuit 523 via the signal-processing circuit 523 by means of the method according to the invention. The levels of the input signals and the output signals can be controlled by a user by means of input means 530 coupled to the processing unit 522. However, it is alternatively possible to control the levels of the signals by means of a further computer program.

In this case, the signals can be controlled by means of an external operating panel. However, it is alternatively possible to display a control unit on a display device 540 which is coupled to the processing unit 522. The control members 211 to 215 (FIG. 2) can be subsequently moved with the aid of the input means 530.

In the embodiment shown, the record carrier according to the invention is a diskette 510. However, the record carrier 510 may also be a CD-ROM or a flash card, but also a mass storage device which is coupled to a WAN such as the Internet. Another embodiment of the record carrier according to the invention is, however, alternatively possible and does not depart from the scope of the invention.

In summary, the invention relates to an apparatus (200) for controlling and mixing signals, each having their individual control member (212, 213, 214, 215). In known mixer apparatuses (100), the direct transfer of the level of the input signal to the output signal cannot be seen directly. Therefore, it is proposed that the control members (212, 213, 214, 215) corresponding to the respective input signals show the direct transfer of the input signal to the output signal. It is proposed to control the level of the output signal as a whole by means of one main control member (211). When the main control member (211) is moved and controls the level of the output signal, the control members (212, 213, 214, 215) corresponding to the respective input signal move along with it and preserve the relationship between the control levels of the individual input signals in the output signal. The invention also relates to a method and a record carrier (510).

1. An apparatus for controlling signal levels, the apparatus comprising
(a) at least two inputs for controllable signals,
(b) an output for supplying an output signal comprising the controllable signals,
(c) a movable main control member adapted to control the level of the output signal,
(d) individual movable control members for each controllable signal of the plurality of controllable signals so as to control the ratios between the mutual levels of the controllable signals in the output signal,
wherein, in operation when controlling the level of the output signal, the ratios between the levels of the controllable signals in the output signal remain equal, characterized in that
(e) the apparatus is further adapted in such a way that the individual control members are coupled to the main control member, such that, when determining the level of the output signal by moving the movable main control member, the individual movable control members move along with the main control member in order that the ratios between the mutual levels of the controllable signals remain equal, and
(f) the transfer of the levels of the controllable signals in the output signal is directly readable from the position of the individual control members.

2. An apparatus as claimed in claim 1, characterized in that the apparatus is further adapted to be such that, in use, the individual control members move along with the movable main control member only when the movable main control member is moved in a first direction, and that the individual control members do not move along with the movable main control member when the movable main control member is moved in a second, opposite direction.

3. A method of controlling signal levels, in which the level of an output signal is controlled by means of a movable main control member, said output signal comprising controllable signals each having their individual movable main control member, wherein the ratios between levels of the controllable signals in the output signal remain equal when controlling the output signal by means of the movable main control member, characterized in that the individual control members are coupled to the main control member, such that, when controlling the level of the output signal by moving the movable main control member, the individual control members move along with the movable main control member, and that the transfer of the levels of the controllable signals is directly shown by the position of the individual control members.

4. A method as claimed in claim 3, characterized in that the individual control members move along with the movable main control member only when the movable main control member is moved in a first direction, and that the individual control members do not move along with the movable main control member when the movable main control member is moved in a second, opposite direction.

5. A record carrier (510) comprising instructions which can be performed by a processor, characterized in that the instructions enable the processor to perform the method as claimed in claim 3.
